(19) United States
(12) Patent Application Publication
(10) Pub. No.: US 2026/0075600 A1
(43) Pub. Date: Mar. 12, 2026

(54) BEAMFORMING METHOD ALLOCATION BASED ON CONGESTION NOTIFICATION

(71) Applicant: T-MOBILE INNOVATIONS LLC, Overland Park, KS (US)

(72) Inventors: Timur Kochiev, Irvine, CA (US); Relin Thomas, Seattle, WA (US)

(21) Appl. No.: 18/882,296

(22) Filed: Sep. 11, 2024

(51) Int. Cl. H04W 72/044; H04L 47/129; H04W 28/02; H04W 72/543

(52) U.S. Cl. CPC H04W 72/046; H04L 47/129; H04W 28/0284; H04W 72/543

(57) ABSTRACT

Systems, methods, and software are disclosed herein for allocating beamforming resources of a base station of a wireless communication network based on congestion notification which includes detecting Explicit Congestion Notification (ECN) data of data traffic of user equipment (UEs) in communication with a base station; determining that the ECN data comprising a congestion notification exceeds a threshold value; and determining an allocation of beamforming resources of the base station among the UEs based on determining that the ECN data comprising a congestion notification exceeding the threshold value.

### TECHNICAL FIELD

Aspects of the disclosure are related to the field of wireless communication networks, particularly traffic management.

### BACKGROUND

In wireless network communications, excessive traffic congestion can lead to excess latency, buffer bloat, and packet loss, where packets are dropped to signal congestion to the sender. Network congestion is particularly detrimental to transmissions associated with time-critical applications such as VoIP (voice over IP), videoconferencing, live streaming, online gaming, and other types of traffic which rely on low latency and low packet loss to provide a high-quality user experience. For example, in cloud gaming and augmented/virtual reality (AR/VR) applications, network congestion can lead to jitter and freezing which degrades the user experience. Conventional efforts to detect congestion within the network infrastructure include detecting excessive packet loss, monitoring network latency, tracking bandwidth utilization, and analyzing patterns of retransmissions.

To address the challenges to speed and reliability of time-critical data transmission, Low Latency, Low Loss, Scalable Throughput (L4S) technology enables traffic management to reduce congestion build-up, thereby reducing the detrimental effects of congestion on transmission. L4S relies on an extension of the Internet Protocol (IP) defining Explicit Congestion Notification (ECN) by which network traffic can be marked in such a way as to signal to ECN-enabled senders to reduce their transmission rates to alleviate a congestion build-up, rather than dropping packets to signal the build-up to a sender. More specifically, when an ECN-aware router detects that traffic congestion is exceeding a traffic congestion threshold, the router marks the IP header of a packet queued at the router to indicate “Congestion Experienced.” This mark, when received at an ECN-aware endpoint, causes the endpoint to echo the congestion indication back to the ECN-aware sender, which in turn causes the sender to reduce its transmission rate. By reducing the transmission rate, congestion is alleviated, resulting in reduced packet loss and improved latency.

### OVERVIEW

Technology is disclosed herein for allocating beamforming resources of a base station of a wireless communication network based on congestion notification in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to detect Explicit Congestion Notification (ECN) data of data traffic of user equipment (UEs) in communication with a base station; determine that the ECN data comprising a congestion notification exceeds a threshold value; and determine an allocation of beamforming resources of the base station among the UEs based on determining that the ECN data comprising a congestion notification exceeding the threshold value.

In another example, a method of operating a computing device comprises detecting ECN data of data traffic of UEs in communication with a base station; determining that the ECN data comprising a congestion notification exceeds a threshold value; and determining an allocation of beamforming resources of the base station among the UEs based on determining that the ECN data comprising a congestion notification exceeding the threshold value.

In yet another example of the technology disclosed herein, a method of operating a computing device comprises detecting ECN data of data traffic of a UE in communication with a base station via a communication link supported by SRS beamforming; determining that the ECN data comprising a congestion notification exceeds a threshold value; and determining, based at least on determining that the ECN data comprising a congestion notification exceeding the threshold value, to switch the communication link to codebook beamforming.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for beamforming allocation based on congestion notification in an implementation.

FIG. 2 illustrates a process for beamforming allocation based on congestion notification in an implementation.

FIG. 3 illustrates an operational environment for beamforming allocation based on congestion notification in an implementation.

FIGS. 4A-4C illustrate workflows for beamforming allocation based on congestion notification in an implementation.

FIG. 5 illustrates an operational architecture of a wireless communication network supporting beam allocation based on congestion notification in an implementation.

FIG. 6 illustrates a computing system suitable for implementing the various operational environments, architectures, processes, scenarios, and sequences discussed below with respect to the other Figures.

### DETAILED DESCRIPTION

In the field of wireless communication networks, beamforming allows base stations of wireless networks to focus a signal to user equipment (UE) in a specific direction. This focused approach not only enhances the signal strength but also improves the efficiency and capacity of the network. Two types of beamforming technique available for wireless communication are predefined beamforming and adaptive beamforming. With adaptive beamforming, reference signals are transmitted by a base station or a UE to assist the base station in determining the optimal beamforming direction. For example, Sounding Reference Signals (SRS) are reference signals transmitted by a UE to a base station for assessing uplink channel quality. By analyzing these reference signals, the base station can dynamically adjust the beamforming weights according to changing channel conditions to maintain an optimal connection with each device. In contrast, codebook-based beamforming, a form of predefined beamforming, involves predefined sets of beamforming vectors stored in a “codebook.” These vectors are used by the network to optimize the use of beamforming resources of a base station by selecting the best beamforming configuration based on the current conditions. In codebook beamforming, to ascertain current conditions, Channel State Information Reference Signals (CSI-RS) transmitted by the base station are used by the UE to assess downlink channel quality and report the quality back to the base station. Codebook beamforming (sometimes referred to as CSI-RS beamforming) may be based on predefined tables or matrices (i.e., a Type I codebook) or on mathematical formulas (i.e., a Type II codebook).

Various implementations are disclosed herein for allocating different types of beamforming resources based on ECN-packet marking of network data traffic. In various implementations, the network can respond to changing network conditions more rapidly based on detecting congestion using ECN technology. In a simple illustration, a base station may employ both codebook and SRS beamforming for communication with various UEs. When the base station detects an increase in the quantity of ECN bits signaling congestion build-up on the network, the base station may switch some UEs from SRS beamforming to codebook beamforming to free up SRS resources for users on the network requiring higher bitrates. By enabling beamforming switching based on detecting ECN bit values, the base station can respond to the congestion build-up in a proactive manner before excessive packet loss occurs, rather than in reaction to detecting the increase in packet loss. By optimizing the distribution of users according to the available beamforming resources, the technology disclosed herein can improve the spectral efficiency and capacity of the network, resulting in better performance for at least the ECN-aware data traffic hosted by the base station.

In various implementations, in addition to congestion indicated by the ECN bits, the allocation of UEs according to beamforming technique may be determined based on other factors such as the radiofrequency (RF) conditions of the UEs and bitrate adjustments made in response to congestion. For example, a UE in a favorable RF environment but encountering a build-up of network congestion may be switched to codebook beamforming based on the device and/or its communication endpoint downgrading the transmission bitrate in response to the congestion. In turn, this may allow a UE using a time-critical application in a poor RF environment (e.g., with high levels of interference) to be switched to SRS beamforming.

In some implementations, the technology disclosed herein can be used to predict network congestion for responding proactively to anticipated congestion. For example, an artificial intelligence model, such as an artificial neural network, can be trained to predict SRS capacity based on training data which includes historical information of ECN usage according to variables such as day, time, region, and application or network slice. Based on its training, the model may be used to anticipate periods of increased demand and to proactively shift data traffic from SRS to codebook beamforming or vice versa to maintain transmission quality for UEs connected to a base station, particularly ECN-aware transmissions.

Technical effects of the technology disclosed herein include faster switching of beamforming technique which allows the network to more rapidly adapt to changing network traffic conditions, such as changes in the RF environment of the UEs serviced by a base station. By reallocating the UEs to the appropriate beamforming technique, the network can respond to the changing conditions by prioritizing certain types of traffic to receive SRS beamforming while shifting lower priority traffic to codebook beamforming. For example, when sender applications reduce the bitrate of their transmissions in response to the congestion notifications of the L4S technology, the base station can prioritize certain types of traffic, e.g., time-critical application traffic or higher bitrate traffic, to use or to continue using SRS beamforming while shifting lower priority traffic to codebook beamforming. For example, the UEs transmitting data at reduced bitrates (in response to the traffic congestion) can be switched to codebook beamforming since SRS beamforming would provide no additional benefit for that user. Beyond enabling rapid response to changing RF conditions, the technology can also be used to predict traffic conditions based on historical ECN data and to proactively respond to current conditions based on the historical data.

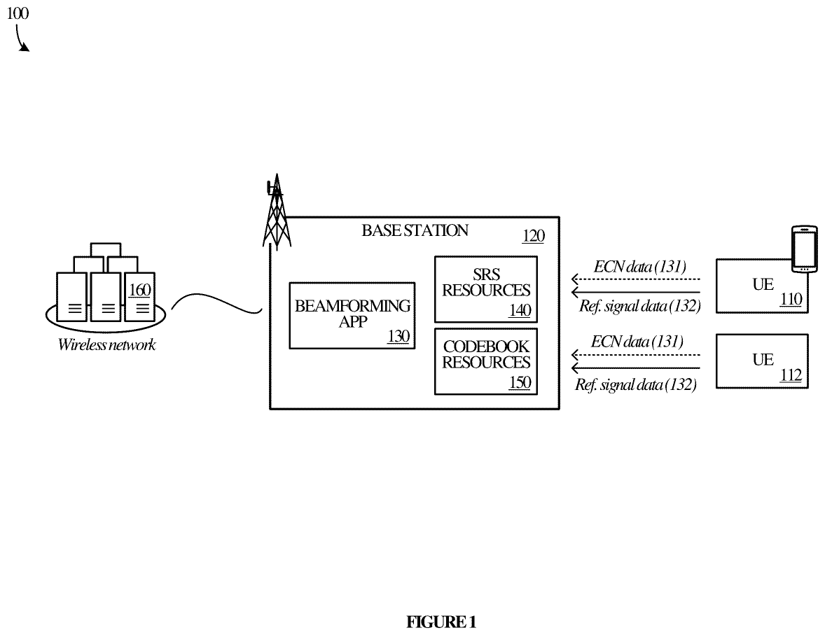

Turning now to the Figures, FIG. 1 illustrates operational environment 100 for beamforming allocation based on congestion notification in an implementation. Operational environment 100 includes wireless network 160 in communication with base station 120 and user equipment (UEs) 110 and 112. Base station 120 includes beamforming application 130 by which beamforming resources of base station 120 are allocated to UEs such as UEs 110 and 112.

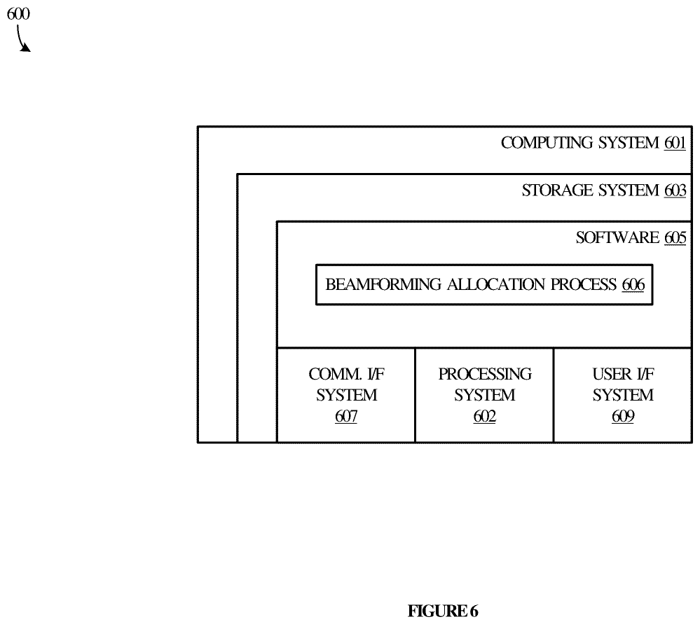

UEs 110 and 112 are representative of L4S-enabled devices, such as smartphones, computers, sensors, controllers, radios, and/or other user apparatus, with processing circuitry for wireless communication with base station 120 of wireless network 160 using protocols such as Fifth Generation New Radio (5G-NR), 5G Advanced, 4G/LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UEs 110 and 112 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 601 in FIG. 6 is broadly representative. UEs 110 and 112 exchanges wireless communication signals with access nodes, such as base station 120, of wireless network 160 over radio frequency bands. UEs 110 and 112 also include functionality by which to signal or respond to network congestion conditions using ECN bits.

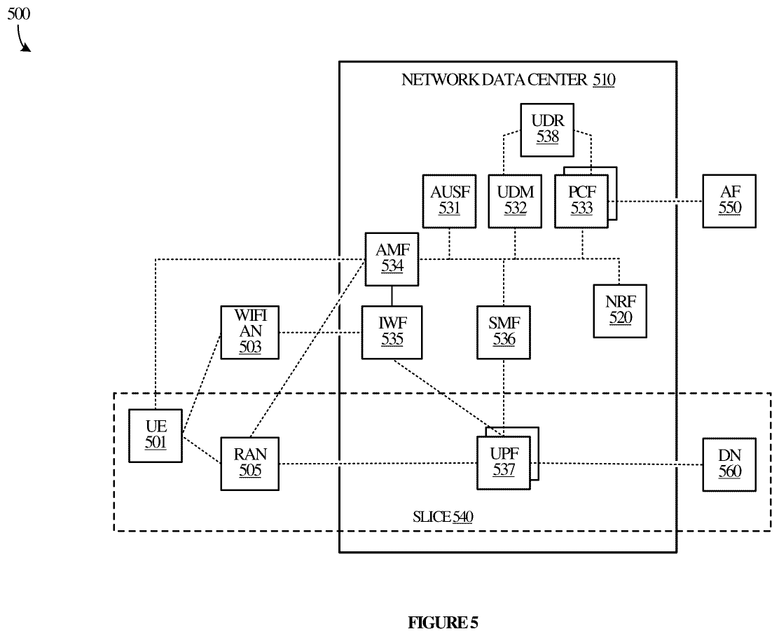

Wireless network 160 is representative of a communication network capable of using a Fifth Generation New Radio (5G-NR), 4G LTE, 6G, or other protocol to communicate with computing devices such as UEs 110 and 112. In an implementation, wireless network 160 is representative of a service-based architecture (SBA) which includes network functions which constitute the control plane and user plane of a wireless communication network core, of which network data center 510 of FIG. 5 is representative. The network functions of wireless network 160 are implemented on one or more suitable computing devices, of which computing device 601 of FIG. 6 is representative. Examples of suitable computing devices include server computers, blade servers, and the like. The network elements of wireless network 160 may be implemented in the context of one or more data centers in a co-located or distributed manner, or in some other arrangement.

Base station 120 is representative of equipment, such as access nodes of Fifth Generation (5G) radio access networks (RANs), access nodes of long-term evolution (LTE) RANs, gNodeBs, eNodeBs, macrocells, NB-IoT access nodes, LP-WAN base stations, wireless relays, Wifi access nodes, and/or other wireless or wireline network transceivers. Base station 120 hosts access networks using radio frequencies to provide wireless network connectivity to devices. To communicate with a network core of wireless network 160, cells or base stations such as base station 120 include receiving unit (RU) circuitry which communicates along fronthaul data paths to distributed unit (DU) circuitry which in turn communicates with central unit (CU) circuitry along midhaul data paths. Although illustrated as a tower, base station 120 may include other physical configurations, including rooftop installations, small-cell sites, distributed antenna systems, vehicle-mounted systems, airborne access nodes, and so on.

Beamforming application 130 of base station 120 is representative of a functionality or service by which base station 120 determines a beamforming technique for a UE in communication with base station 120. In various implementations, beamforming application 130 receives inputs including ECN data 131 and reference signal data 132 indicative of the quality of the RF environment from a UE such as UE 110 or 112 and determines a beamforming technique such as SRS beamforming or codebook beamforming for wireless communication with the device. In some scenarios, beamforming application 130 also receives transmission parameters of applications (not shown) sending data to a UE such as bitrate and includes the transmission parameters in selecting a beamforming technique for the UE. In some implementations, beamforming application 130 includes a functionality or service for projecting network congestion according to a day, time, and location. For example, beamforming application 130 may include an AI model or generative AI model trained based on data from historical ECN data to return a projected level of network congestion at a given day, time, and location.

SRS resources 140 is representative of a functionality implemented in hardware or software of base station 120 to host communication links with various UEs using SRS beamforming. Similarly, codebook resources 150 is representative of a functionality implemented in hardware or software of base station 120 to host communication links with various UEs using codebook beamforming.

In a brief operational scenario of operational environment 100, UEs 110 and 112 are in communication with base station 120 including sending and receiving data carried by wireless network 160 to/from endpoints (not shown) such as other UEs or cloud-based destinations such as application servers, web servers, etc. For the sake of illustration, it will be assumed that the communication link between base station 120 and UE 110 is directed from base station 120 to UEs 110 and 112 using SRS beamforming of SRS beamforming resources 140.

Continuing with the operational scenario, beamforming application 130 detects an increase in the number of ECN bits signaling congestion in data packet headers transiting wireless network 160. In response to the quantity of ECN bits signaling congestion exceeding a threshold value, beamforming application 130 determines that base station 120 should continue using SRS beamforming for communication with UE 110, but that communication with UE 112 should switch to codebook beamforming of codebook beamforming resources 150.

Beamforming application 130 continues to monitor conditions which could affect data transmission to determine the most appropriate beamforming allocation among the UEs. For example, beamforming application 130 monitors RF conditions of UEs 110 and 112 via SRS or CSI reference signals of reference signals 132 transmitted by the UEs and network congestion conditions via ECN data 131 from the UEs as well as other data (e.g., transmission bitrates). When beamforming application 130 detects that the number of congestion-signaling ECN bits has fallen below the threshold, beamforming application 130 may again reallocate SRS resources 140 and codebook resources 150 among the UEs. Continuing with the previous example, if UE 112 signals via CSI data of reference signals 132 that its RF conditions have become unfavorable, in the absence of excessive network congestion, beamforming application 130 may switch UE 112 back to SRS beamforming.

Thus, in determining which devices will switch to or continue using SRS beamforming and which devices will switch to or continue using codebook beamforming of base station 120, beamforming application 130 may consider, in addition to network congestion conditions signaled by the ECN markings, the RF environment of the various UE devices and any adjustments to the bitrates made by sender applications in response to the increase in ECN bits signaling congestion. Beamforming application 130 may also consider Quality of Service (QoS) requirements of the network slices of the data transmissions based on the type of application which the UE is using. For example, a UE using a time-critical application such as a videoconferencing application or virtual reality application with higher bitrate, lower latency, and low packet loss requirements, may be switched to or remain on a communication link supported by SRS beamforming. On the other hand, a UE using an application which is not time-critical (e.g., web browsing) may be switched to or remain on a communication link supported by codebook beamforming.

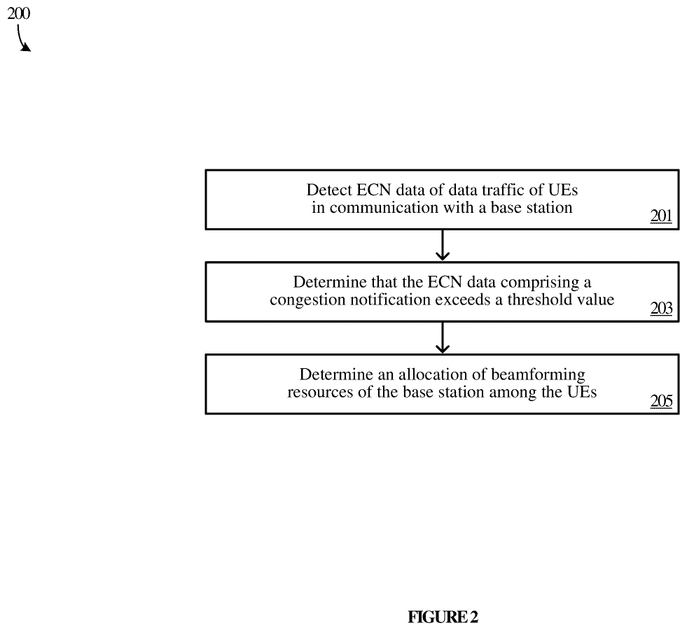

FIG. 2 illustrates a method for beamforming allocation based on congestion notification in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, a computing device detects ECN data of data traffic of UEs in communication with a base station (step 201). In an implementation, a computing device, such as a base station of a wireless communication network, detects ECN data in ECN-enabled data traffic transiting the base station to/from UEs in communication with the network. The base station may host communication links to the various UEs using predefined or adaptive beamforming, e.g., codebook or SRS beamforming, according to the operating conditions of the UEs. The operating conditions can include congestion levels on the network, RF conditions of the devices, bitrate, and/or QoS requirements of the device activity or network slice on the network.

To detect the ECN data including ECN data which includes a congestion notification, in an implementation, the computing device reads packet headers of data packets transiting the base station to extract ECN bit values embedded in the headers. The ECN bit values may be set in the IP header of a data packet by an ECN-aware router in the communication path of the data packet. ECN-enabled devices at either end of the communication path can read ECN bit values and respond accordingly. For example, if an ECN-aware router marks a packet header to indicate that there is a build-up of network congestion, the ECN-enabled device at the receiving end may respond by downgrading its transmission bitrate and echoing the congestion indication to the sending device (via the ECN-Echo (ECE) flag) in the TCP header of an acknowledgement packet so it can also downgrade its transmission bitrate. By downgrading the bitrate, the congestion build-up may be slowed or even mitigated for network data traffic. To mark the packet, the ECN-aware router sets the rightmost bits of the Traffic Class of the IP header to a value which indicates whether the packet is ECN-enabled and whether congestion has been experienced. For example, ECN bit values of “01” or “10” indicates that the packet is ECN-enabled; “11” indicates that the packet is ECN-enabled and that the router has experienced network congestion. Bit values of “00” indicate the packet is not ECN-enabled.

The computing device determines that the ECN data comprising a congestion notification exceeds a threshold value (step 203). In an implementation, as ECN-capable packets transit the computing device, the computing device tracks a quantity of the packet headers indicating that congestion has been experienced. For example, the computing device may track the quantity of packets which include congestion-signaling ECN bits (e.g., “11” bits) relative to all of the ECN-enabled packets for a specified period of time. The computing device determines an actionable level of network congestion has occurred when the quantity exceeds a threshold value. In some cases, the computing device may track the rate at which it receives packets signaling congestion relative to all ECN-enabled packets; when the rate exceeds a threshold value, the computing device determines that an actionable level of network congestion has been reached.

In some cases, packet header data including the ECN data may be fed to an artificial intelligence (AI) model that has been trained to detect network congestion based on patterns arising in a data stream of packet header and contextual information. For example, the AI model may be an artificial neural network which has been trained on historical ECN data and corresponding day, time, and geographic location data which has been correlated to congestion classifications (e.g., congested or not congested) or to congestion regression values (e.g., a level or quantity of congestion). In some cases, the AI model may also be trained on other data corresponding to the historical ECN values, such as transmission bitrate, applicable network slice or QoS parameters, or the type of data being transmitted, such as the identity of the transmitter or sender or the type of application with which the UE is communicating. Subsequent to training, the model may be used to determine whether congestion is occurring or a level of network congestion based on recent or current data captured by the computing device.

The computing device determines an allocation of beamforming resources of the base station among the UEs (step 205). In an implementation, upon determining that a particular level of network congestion has been reached or is occurring, the computing device evaluates and selects beamforming techniques for the various UEs in communication with the base station. For example, the computing device may evaluate the beamforming technique of each UE currently being supported by the base station and determine for each device whether to continue with (i.e., not switch) the current beamforming configuration or whether to switch the device to another type of beamforming. The determinations of whether to switch the beamforming of a particular UE may be based on factors such as the current type of beamforming that the device is using, the RF environment of the device (e.g., favorable, poor), the transmission bitrate of communications to/from the device, or the network slice or QoS parameters of the device, or any combination of the factors. Moreover, the number of devices subjected to beamforming switching may vary depending on the level of congestion detected from the ECN-enabled data traffic. For example, should the detected congestion become severe, the computing device may reallocate the beamforming resources more aggressively to optimize the distribution of beamforming resources.

In scenarios where the SRS beamforming is the more desirable but more demanding beamforming configuration as compared to codebook beamforming, the computing device may evaluate the communication links to UEs which are supported by SRS beamforming to determine which of the UEs can be switched to codebook beamforming. To determine which of the UEs can be switched to codebook beamforming, the computing device may identify which of the UEs are subject to a transmission rate reduction based on the congestion notification. The computing device may prioritize those UEs for switching to codebook beamforming.

Having reallocated the beamforming resources of the base station in response to the heightened congestion, the computing device may continue to monitor the congestion based on the ECN-enabled data traffic and reallocate beamforming resources in response to increases or decreases of the network congestion.

Referring again to FIG. 1, operational environment 100 illustrates a brief example of process 200 as employed by elements of operational environment 100. In operation, beamforming application 130 executed by base station 120 detects ECN data 131 of data traffic of UEs 110 and 112 for which base station 120 is hosting service. UEs 110 and 112 represent ECN-enabled devices; beamforming application 130 reads ECN data from the data packet headers for transmission to/from the devices. Based on the ECN data, beamforming application 130 detects a level of network congestion, such as detecting a higher than usual rate of congestion-signaling ECN bits in the ECN data traffic.

Upon determining that the level of network congestion has exceeded a normal or threshold level, beamforming application 130 determines an allocation of beamforming resources of base station 120. For example, in response to the detected congestion, beamforming application 130 may determine that UE 110 is to be switched from using SRS resources 140 to codebook resources 150 based on a bitrate adjustment of the device in response to the congestion signaling. Beamforming application 130 may also determine that UE 112 should not be switched from its current beamforming configuration. For example, if base station 120 is currently using codebook beamforming resources 150, beamforming application 130 may determine that no switch is necessary. Alternatively, if base station 120 is currently using SRS resources 140 for UE 112, beamforming application 130 may determine that it is appropriate for UE 112 that no switch is necessary based on the higher bitrate requirement and/or unfavorable RF conditions to which UE 112 is subjected based on reference signals 132 from UE 112.

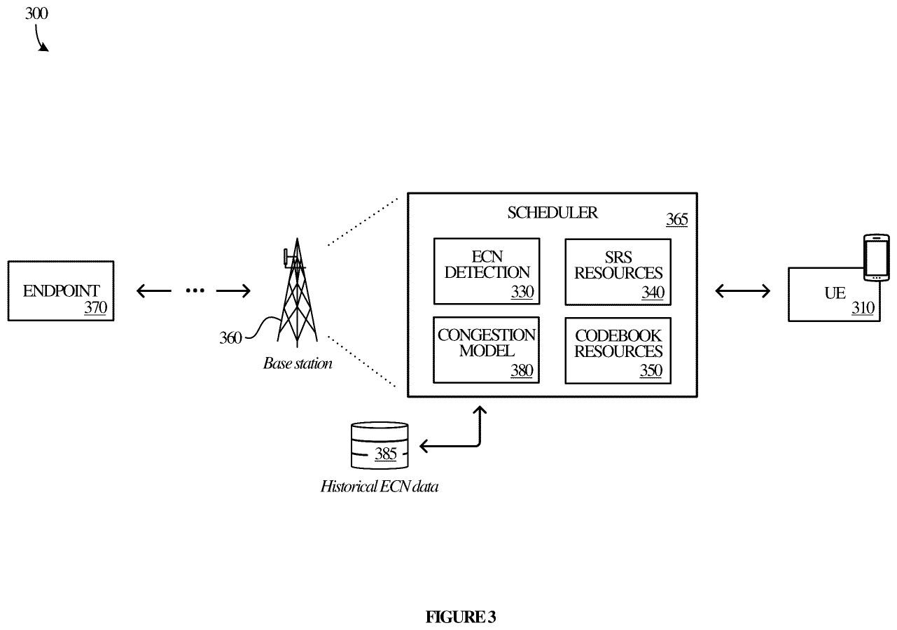

Turning now to FIG. 3, FIG. 3 illustrates operational environment 300 for allocating beamforming resources based on congestion notifications of ECN data traffic in an implementation. Operational environment 300 includes base station 360 in communication with UE 310 and endpoint 370 via one or more wireless network cores (not shown). Base station 360 includes scheduler 365 which in turn includes ECN detection module 330, SRS resources 340, codebook resources 350, and congestion model 380. Congestion model 380 is trained based on historical ECN data 385.

Base station 360 is representative of equipment, such as access nodes of Fifth Generation (5G) radio access networks (RANs), access nodes of long-term evolution (LTE) RANs, gNodeBs, eNodeBs, macrocells, NB-IoT access nodes, LP-WAN base stations, wireless relays, Wifi access nodes, and/or other wireless or wireline network transceivers. Base station 120 hosts access networks using radio frequencies to provide wireless network connectivity to devices. To communicate with a network core of a wireless network, cells or base stations such as base station 360 include receiving unit (RU) circuitry which communicates along fronthaul data paths to distributed unit (DU) circuitry which in turn communicates with central unit (CU) circuitry along midhaul data paths. Although illustrated as a tower, base station 360 may include other physical configurations, including rooftop installations, small-cell sites, distributed antenna systems, vehicle-mounted systems, airborne access nodes, and so on.

Base station 360 includes scheduler 365 which is representative of a functionality implemented in hardware or software which performs tasks relating to resource allocation of a base station including allocation of beamforming resources such as SRS resources 340 (of which SRS resources 140 is representative) and codebook resources 350 (of which codebook resources 150 is representative). Scheduler 365 may also perform tasks relating to QoS management, load balancing, and power control. Scheduler 365 may include in some implementations congestion model 380 for predicting network congestion and which has been trained using historical ECN data 385.

Congestion model 380 is representative of a functionality of base station 360 implemented in hardware or software by which scheduler 365 predicts network congestion based on historical congestion data including historical ECN data 385. In some implementations, congestion model 380 is a trained AI model, such as an artificial neural network, which receives input including ECN data from UEs such as UE 310 as well as contextual information such as time, day, and location of historical network congestion events, and information relating to the type or source of data traffic or network slices associated with historical congestion events.

UE 310 is representative of an L4S-enabled device, such as a smartphone, computer, sensor, controller, radio, and/or other user apparatus, with processing circuitry for wireless communication with base station 360 of a wireless network using protocols such as Fifth Generation New Radio (5G-NR), 5G Advanced, 4G/LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 310 can include a device such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 601 in FIG. 6 is broadly representative. UE 310 exchanges wireless communication signals with access nodes, such as base station 360, of a wireless network over radio frequency bands. UE 310 also includes functionality by which to signal or respond to network congestion conditions using ECN bits.

Endpoint 370 is representative of an endpoint of a communication path to UE 310 hosted by base station 360 of a wireless communication network. Endpoint 370 can include another UE, a data network, or a cloud-based destination such as a web server or application server. Endpoint 370 can include, for example, an application server hosting a time-critical application or application for real-time communication, such as videoconferencing, online gaming, AR/VR, or live streaming applications.

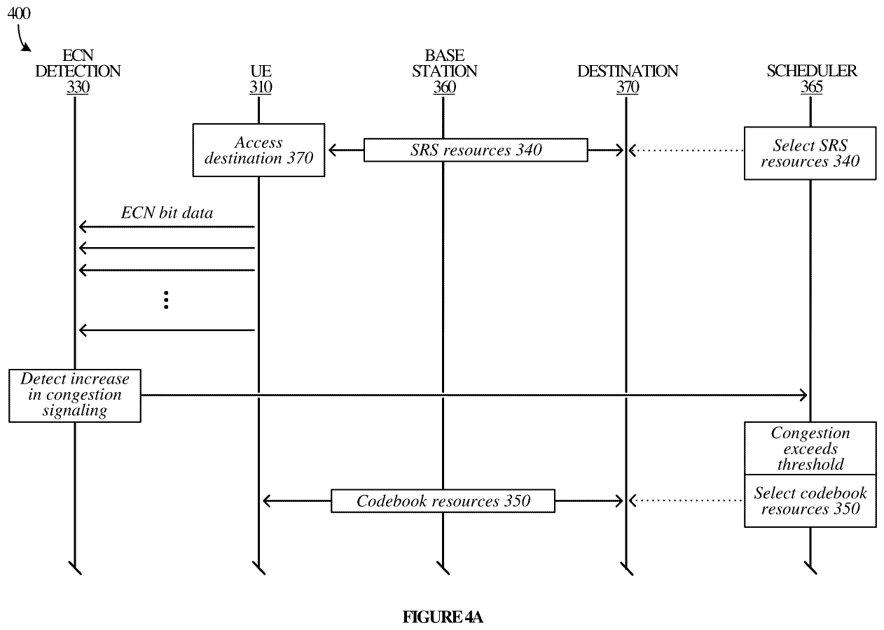

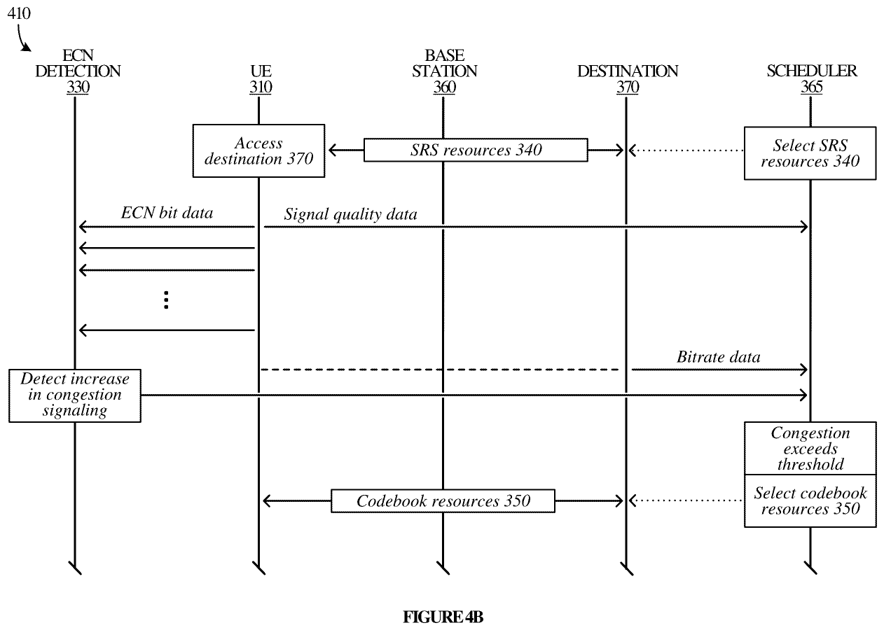

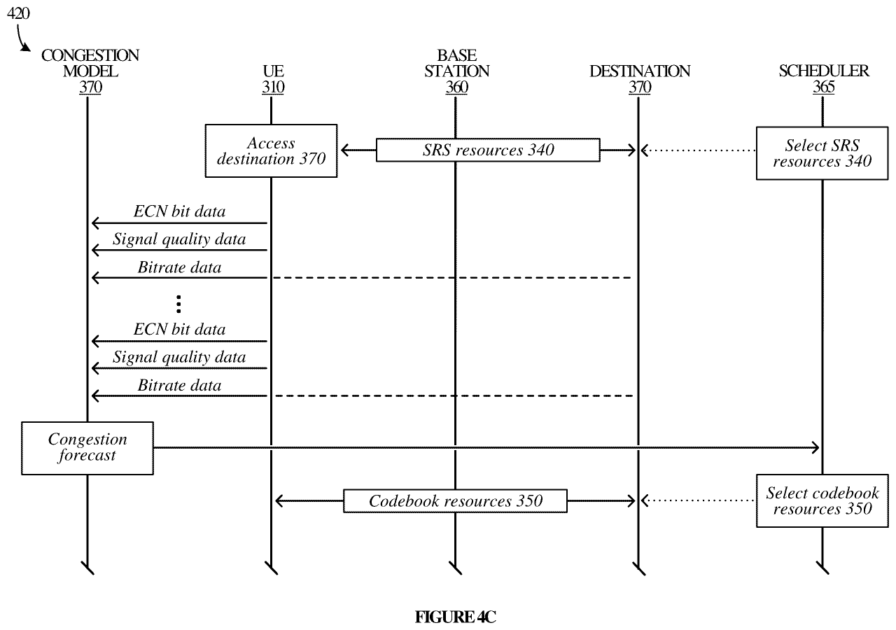

FIGS. 4A-4C illustrate workflows 400, 410, and 420 employed in illustrations of allocating beamforming resources based on congestion notifications of ECN data traffic in an implementation, referring to elements of operational environment 300. In workflow 400, UE 310 connects with endpoint 370 via base station 360 of a wireless communication network. For example, endpoint 370 may be an application server for a videoconferencing application which UE 310 is accessing for a video call. Scheduler 365 allocates SRS beamforming 340 for data transmitted to/from UE 310 with respect to endpoint 370. As data traffic is transmitted between UE 310 and endpoint 370, ECN detection module 330 of scheduler 365 receives ECN bit data of the data traffic including ECN bit values of packet headers. ECN detection 330 monitors network congestion levels via the ECN bit data of UE 310 as well as other ECN-enabled UEs communicating with base station 360.

As the illustrative scenario continues, ECN detection module 330 detects an increase in ECN bit values indicating that congestion has been experienced along the communication path between UE 310 and endpoint 370. In response to detecting the heightened level of congestion signaling in the ECN bit data, ECN detection 330 notifies scheduler 365 which determines that level of network congestion correlated to the ECN bit data has exceeded a threshold necessitating an action or response. Scheduler 365 determines that with the rise in network congestion with respect to the ECN-enabled data traffic, the allocation of UEs to the beamforming resources of base station 360, i.e., SRS resources 340 and codebook resources 350, may be modified. Accordingly, scheduler 365 determines that UE 310 is to be switched to codebook beamforming using codebook resources 350. Subsequent to the switch, ECN detection 330 continues to monitor network congestion levels via ECN bit data from UE 310 and other UEs and may reallocate the beamforming resources if/when the network congestion changes.

Workflow 410 of FIG. 4B proceeds in a similar manner as workflow 400. In workflow 410, however, scheduler 365 receives additional data by which to determine the allocation of beamforming resources. The additional data can include signal quality data from UE 310 based on SRS reference signals and transmission bitrate data of transmissions from endpoint 370 or UE 310. In the illustrative scenario, upon detecting that congestion notifications in ECN bit data from UE 310, scheduler 365 may determine that UE 310 should be switched from SRS beamforming to codebook beamforming based on the heightened congestion detected in the ECN bit data, but also taking into account that transmission data rates between UE 310 and endpoint 370 may also be reduced in response to the congestion. Further, scheduler 365 may determine that the RF environment of UE 310 is favorable or at least suitable for codebook beamforming.

Workflow 420 of FIG. 4C proceeds in a manner similar to that of workflows 400 and 410. In workflow 420, however, congestion model 380 provides a congestion forecast based on data received from UE 310. Data received from UE 310 includes ECN bit data and signal quality data. Congestion model 380 also receives transmission bitrate data from UE 310 or endpoint 370. Based on the inputs and in accordance with its training, congestion model 380 generates a forecast about network congestion, such as a prediction of congestion levels or when a level of congestion triggering reallocation of beamforming resources will occur.

FIG. 5 illustrates exemplary wireless communication system 500 that serves wireless User Equipment (UE) 501. Wireless communication system 500 includes UE 501, Wifi Access Node (AN) 503, 5GNR RAN 505, Interworking Function (IWF) 535, Access and Mobility Management Function (AMF) 534, Authentication Server Function (AUSF) 531, Unified Data Management (UDM) 532, Policy Control Functions (PCFs) 533, Session Management Function (SMF) 536, User Plane Function (UPF) 537, Uniform Data Repository (UDR) 538, and Application Function (AF) 550. UDR 538 stores network data including subscriber profiles including identities, subscription details, service preferences, authentication credentials, and billing information. UDR 538 may also store policy data such as network rules, access rules, mobility rules, charging rules, and so on. AF 550 may provide policies applicable to control plane functions, that is, to the application, presentation, and/or session layers of the OSI protocol stack. IWF 535 includes non-3GPP IWFs (N3IWFs) for providing untrusted non-3GPP access to network data center 510, such as access via a non-cellular access network.

Continuing with wireless communication system 500, wireless network slice 540 includes UPF 537 and SMF 536. Wireless network slice 540 is representative of a dynamically allocated slice of finite duration selected for hosting service from DN 560 to UE 501 according to the technology disclosed herein, including process 200 or workflow 400. DN 560 is representative of a data network, Internet access, third-party resource, or other endpoint of an end-to-end communication path from UE 501.

In an implementation, UE 501 communicates with network data center 510 via 5G-NR access node 505 or Wifi access node 503. UE 501 requests access to DN 560 via the communication network of network data center 710, e.g., via wireless network slice 540. RAN 505 determines a beamforming technique for wireless communication with UE 501, such as predefined or adaptive beamforming, based on congestion notifications embedded in packet headers of data to or from the device.

FIG. 6 illustrates computing device 601 that is representative of any system or collection of systems in which the various processes, programs, services, and scenarios disclosed herein may be implemented. Examples of computing device 601 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609 (optional). Processing system 602 is operatively coupled with storage system 603, communication interface system 607, and user interface system 609.

Processing system 602 loads and executes software 605 from storage system 603. Software 605 includes and implements beamforming allocation process 606, which is (are) representative of the beamforming allocation processes discussed with respect to the preceding Figures, such as process 200 and workflows 400, 410, and 420. When executed by processing system 602, software 605 directs processing system 602 to operate as described herein for at least the various processes, operational scenarios, and sequences discussed in the foregoing implementations. Computing device 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including beamforming allocation process 606) may be implemented in program instructions and among other functions may, when executed by processing system 602, direct processing system 602 to operate as described with respect to the various operational scenarios, sequences, and processes illustrated herein. For example, software 605 may include program instructions for implementing a beamforming allocation process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to support beamforming allocation in an optimized manner. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S. C. § 112(f) will begin with the words “means for,” but use of the term “for” in any other context is not intended to invoke treatment under 35 U.S. C. § 112(f). Accordingly, the applicant reserves the right to pursue additional claims after filing this application to pursue such additional claim forms, in either this application or in a continuing application.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
detect Explicit Congestion Notification (ECN) data of data traffic of user equipment (UEs) in communication with a base station of a wireless communication network;
determine that the ECN data comprising a congestion notification exceeds a threshold value; and
determine an allocation of beamforming resources of the base station among the UEs based on determining that the ECN data comprising a congestion notification exceeding the threshold value.

2. The computing apparatus of claim 1, wherein to determine the allocation of the beamforming resources of the base station among the UEs, the program instructions direct the computing apparatus to switch a UE of the UEs from SRS beamforming to codebook beamforming.

3. The computing apparatus of claim 2, wherein to determine the allocation of the beamforming resources of the base station among the UEs, the program instructions further direct the computing apparatus to determine the allocation based on a radiofrequency environment of the UE.

4. The computing apparatus of claim 2, wherein to determine the allocation of the beamforming resources of the base station among the UEs, the program instructions further direct the computing apparatus to determine the allocation based on a bitrate reduction of transmissions associated with the UE.

5. The computing apparatus of claim 1, wherein to determine the allocation of the beamforming resources of the base station among the UEs, the program instructions direct the computing apparatus to switch a UE of the UEs from codebook beamforming to SRS beamforming.

6. The computing apparatus of claim 1, wherein to determine the allocation of the beamforming resources of the base station among the UEs, the program instructions direct the computing apparatus to switch a UE of the UEs from predefined beamforming to adaptive beamforming.

7. The computing apparatus of claim 1, wherein to detect the ECN data of the data traffic of the UEs in communication with the base station, the program instructions direct the computing apparatus to read ECN bits in packet headers of the data traffic.

8. The computing apparatus of claim 7, wherein to determine that the ECN data comprising a congestion notification exceeds the threshold value, the program instructions direct the computing apparatus to compute a quantity of packet headers comprising a congestion notification relative to a quantity of packet headers of ECN-enabled data traffic of the data traffic.

9. A method of operating a computing device comprising:
detecting Explicit Congestion Notification (ECN) data of data traffic of user equipment (UEs) in communication with a base station of a wireless communication network;
determining that the ECN data comprising a congestion notification exceeds a threshold value; and
determining an allocation of beamforming resources of the base station among the UEs based on determining that the ECN data comprising a congestion notification exceeding the threshold value.

10. The method of claim 9, wherein determining the allocation of the beamforming resources of the base station among the UEs comprises switching a UE of the UEs from SRS beamforming to codebook beamforming.

11. The method of claim 10, wherein determining the allocation of the beamforming resources of the base station among the UEs comprises determining the allocation based on a radiofrequency environment of the UE.

12. The method of claim 10, wherein determining the allocation of the beamforming resources of the base station among the UEs comprises determining the allocation based on a bitrate reduction of transmissions associated with the UE.

13. The method of claim 9, wherein determining the allocation of the beamforming resources of the base station among the UEs comprises switching a UE of the UEs from codebook beamforming to SRS beamforming.

14. The method of claim 9, wherein determining the allocation of the beamforming resources of the base station among the UEs comprises switching a UE of the UEs from predefined beamforming to adaptive beamforming.

15. The method of claim 9, wherein detecting the ECN data of the data traffic of the UEs in communication with the base station comprises to read ECN bits in packet headers of the data traffic.

16. The method of claim 9, wherein to determining that the ECN data comprising a congestion notification exceeds the threshold value comprises computing a quantity of packet headers comprising a congestion notification relative to a quantity of packet headers of ECN-enabled data traffic of the data traffic.

17. A method of operating a computing device comprising:
detecting Explicit Congestion Notification (ECN) data of data traffic of a user equipment (UE) in communication with a base station of a wireless communication network via a communication link supported by SRS beamforming;
determining that the ECN data comprising a congestion notification exceeds a threshold value; and
determining, based at least on determining that the ECN data comprising a congestion notification exceeding the threshold value, to switch the communication link to codebook beamforming.

18. The method of claim 17, wherein determining to switch the communication link to codebook beamforming is further based on a radiofrequency environment of the UE.

19. The method of claim 17, wherein determining to switch the communication link to codebook beamforming is further based on a bitrate reduction of transmissions associated with the UE.

20. The method of claim 17, wherein determining that the ECN data comprising a congestion notification exceeds the threshold value comprises computing a quantity of packet headers comprising a congestion notification relative to a quantity of packet headers of ECN-enabled data traffic of the data traffic.
